(19) United States
(12) Patent Application Publication
(10) Pub. No.: US 2025/0102084 A1
(43) Pub. Date: Mar. 27, 2025

(54) FLUID CONDUIT STRUCTURE AND APPLICATION METHOD THEREOF

(71) Applicant: TING-JUI WANG, New Taipei City (TW)

(72) Inventor: TING-JUI WANG, New Taipei City (TW)

(21) Appl. No.: 18/471,330

(22) Filed: Sep. 21, 2023

(51) Int. Cl. F16L 9/19; F16L 41/02

(52) U.S. Cl. CPC F16L 9/19; F16L 41/02

(57) ABSTRACT

A fluid conduit structure includes a first conduit, a second conduit, a first blocking body, and a second blocking body. The first conduit and the second conduit include a first body portion and a second body portion extending along a conduction direction. The first blocking body is movably assembled to the first body portion and is used to close the first conduit. The second blocking body is provided in the second body portion and is used to close the second conduit. The second blocking body is used to enter the first body portion to push against the first blocking body, and when the second blocking body pushes against the first blocking body, the first blocking body and the second blocking body open the first conduit and the second conduit to generate a flow line in the first body part.

### BACKGROUND OF THE INVENTION

### 1. Field of the Invention

The present disclosure relates to technology for conducting fluid, and in particular to a fluid conduit structure and an application method thereof conducting one conduit to another conduit.

### 2. Description of the Related Art

Traditionally, when connecting two pipes used to flow fluid, the valves on both sides must be closed or the source of the supplied fluid must be determined to be closed before the connection of the lines can be made. After the connection is completed, the valve or the source of the supplied fluid is opened to allow the fluid to flow, resulting in a very complicated process.

### BRIEF SUMMARY OF THE INVENTION

The present disclosure provides a fluid conduit structure and an application method thereof, with a view to achieving the purpose of simplifying the operation process of conducting two conduits.

An aspect of the present disclosure provides a fluid conduit structure, including a first conduit, a second conduit, a first blocking body, and a second blocking body. The first conduit and the second conduit respectively include a first body portion and a second body portion extending along a conduction direction. The first blocking body is movably assembled to the first body portion and is used to close the first conduit. The second blocking body is provided in the second body portion and is used to close the second conduit. The second blocking body is used to enter the first body portion to push against the first blocking body, and when the second blocking body pushes against the first blocking body, the first blocking body and the second blocking body open the first conduit and the second conduit to generate a flow line in the first body part, and the first blocking body or the second blocking body is not perpendicular to the conduction direction.

Another aspect of the present disclosure provides a fluid conduit structure, including a first conduit, a first blocking body, a second blocking body, or a pushing body. The first blocking body is movably assembled to the first body portion and is used to close the first conduit. The second blocking body or the pushing body is used to push against the first blocking body, and when the second blocking body or pushing body pushes against the first blocking body, the first blocking body and the second blocking body or pushing body open the first conduit to generate a flow line in the first body part, and the first blocking body or the second blocking body or pushing body is not perpendicular to the conduction direction.

Still another aspect of the present disclosure provides an application method of a fluid conduit structure, which uses the fluid conduit structure as the aspect described above to conduct the first conduit to another conduit.

Accordingly, only a plugging and pulling action of the first conduit relative to another conduit needs to be carried out, and the first conduit and the other conduit can be quickly connected or separated, thereby realizing the purpose of simplifying the operation process.

### BRIEF DESCRIPTION OF THE DRAWINGS

FIG. 1 is a schematic perspective view of actuation of a fluid conduit structure of an embodiment of the present disclosure.

FIG. 2 is a schematic plan view of a section of the orthographic projection to the first body portion in the conduction direction after the first blocking body and the second blocking body of FIG. 1 engaging and pushing.

FIG. 3 is a schematic side view when the first blocking body and the second blocking body being perpendicular to the conduction direction.

FIG. 4 is a schematic plan view of a section of the orthographic projection to the first body portion in the conduction direction after the first blocking body and the second blocking body of FIG. 3 are engaging and pushing.

FIG. 5 is a schematic sectional view of an engaged structure with an arc face between the first blocking body and the second blocking body of the fluid conduit structure of an embodiment of the present disclosure.

FIG. 6 is a schematic sectional view of an engaged structure with a curved face between the first blocking body and the second blocking body of the fluid conduit structure of an embodiment of the present disclosure.

FIG. 7 is a schematic perspective view of the actuation of the fluid conduit structure of an embodiment of the present disclosure.

FIG. 8 is a schematic perspective view of the first conduit along the conduction direction corresponding to FIG. 7.

FIG. 9 is a schematic perspective view of the actuation of the fluid conduit structure of an embodiment of the present disclosure.

FIG. 10 is a schematic perspective view of the actuation of the fluid conduit structure of an embodiment of the present disclosure.

FIG. 11 is a schematic perspective view of the first conduit along the conduction direction corresponding to FIG. 10.

FIG. 12 is a schematic perspective view of the actuation of the fluid conduit structure of an embodiment of the present disclosure.

FIG. 13 is a schematic perspective view of the fluid conduit structure of an embodiment of the present disclosure.

FIG. 14 is a schematic perspective view of the actuation of the fluid conduit structure of an embodiment of the present disclosure.

FIG. 15 a schematic perspective view of the actuation of the fluid conduit structure of an embodiment of the present disclosure.

FIG. 16 is a schematic view of a combination of the second body part, the second blocking body, and the abutment section along the conduction direction corresponding to FIG. 15.

FIG. 17 is a schematic view of a combination of the first body portion and the first blocking body along the conduction direction corresponding to FIG. 15.

### DETAILED DESCRIPTION OF THE INVENTION

To facilitate understanding of the purpose, characteristics and effects of the present disclosure, embodiments together with the attached drawings for the detailed description of the present disclosure are provided as below.

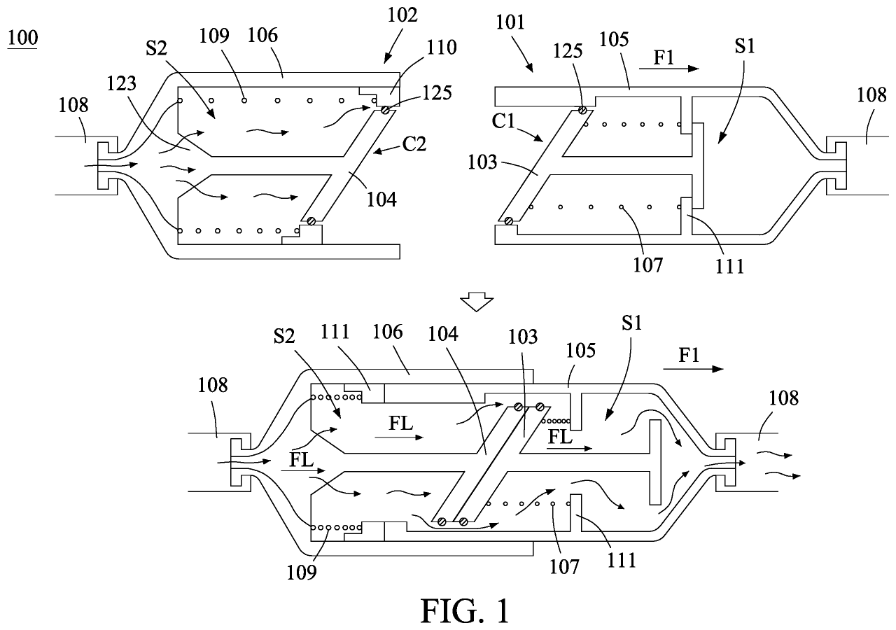

Referring to FIGS. 1, and 12-15, an embodiment of the present disclosure provides a fluid conduit structure 100, including a first conduit 101, a second conduit 102, a first blocking body 103 and a second blocking body 104. The first conduit 101 and the second conduit 102 respectively include a first body portion 105 and a second body portion 106 extending along a conduction direction F1. The first blocking body 103 is movably assembled to the first body portion 105 and is used to close the first conduit 101. The second blocking body 104 is provided in the second body portion 106 and is used to close the second conduit 102. The second blocking body 104 is used to enter the first body portion 105 to push against the first blocking body 103, and when the second blocking body 104 pushes against the first blocking body 103, the first blocking body 103 and the second blocking body 104 open the first conduit 101 and the second conduit 102 to generate a flow line FL in the first body portion 105, and the first blocking body 103 or the second blocking body 104 is not perpendicular to the conduction direction F1.

Referring to FIGS. 1, and 12-15, an embodiment of the present disclosure includes the first conduit 101, the first blocking body 103, and the second blocking body 104.

An embodiment of the present disclosure provides an application method of a fluid conduit structure, which uses the fluid conduit structure 100 as described above to conduct the first conduit 101 to another passing body, for example, the second conduit 102.

As described above, only a plugging and pulling action of the first conduit 101 relative to another passing body (e.g., the second conduit 102) needs to be carried out and the first conduit 101 and the other passing body can be quickly connected or separated, thereby realizing the purpose of simplifying the operation process.

Referring to FIGS. 1, 7, 9-10, and 12-15, in an embodiment, the fluid conduit structure 100 further includes a first elastic element 107. The first conduit 101 includes a first body portion 105. The first body portion 105 has a first conduction space S1. The first blocking body 103 is located in the first conduction space S1 and movably assembled to the first body portion 105. The first elastic element 107 is abutted between the first body portion 105 and the first blocking body 103, so that the first blocking body 103 remains closing the first conduction space S1, and the first blocking body 103 is used to be pushed to close the first conduction space S1.

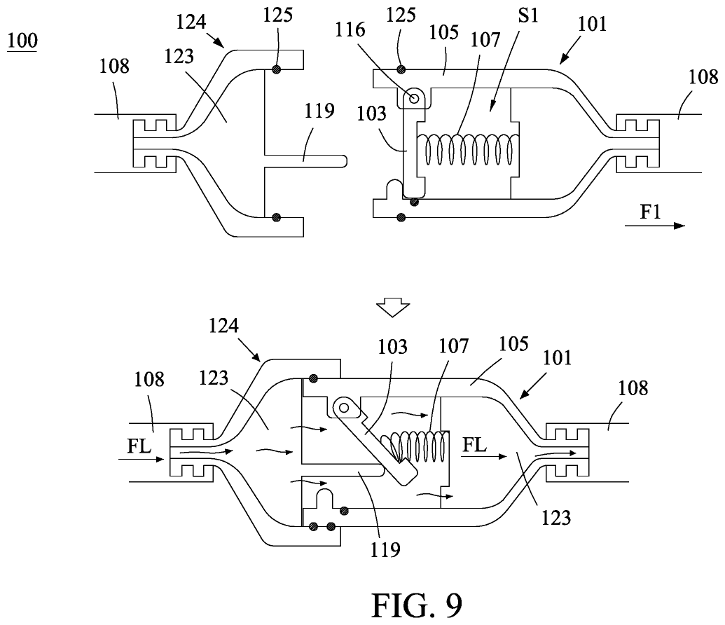

As shown in FIGS. 1, 7, 10, 12-13, and 15, the first conduit 101 and the second conduit 102 may respectively be connected to a sealing body 108 to flow fluid. The sealing body 108 may be a tube body, a rigid pipe body, a bolting body, a flexible tube body, a plugging body, a sleeve barrel body, a sleeve body, a casing body, a locking body, a fastening body, or a welding body. In FIG. 9, the first conduit 101 is used to connect to a connector device 124, and the connector device 124 is connected to the sealing body 108.

As shown in FIGS. 1, 7, 10, and 12-15, the fluid conduit structure 100 of an embodiment of the present disclosure may further include a second elastic element 109. The second body portion 106 has a second conduction space S2. The second blocking body 104 is located in the second conduction space S2 and movably assembled to the second body portion 106. The second elastic element 109 is abutted between the second body portion 106 and the second blocking body 104 so that the second blocking body 104 remains closing the second conduction space S2. The second conduit 102 and the first conduit 101 are engaged, so that the first blocking body 103 and the second blocking body 104 leave the positions that close the first conduction space S1 and the second conduction space S2, and then the second conduit 102 is connected to the first conduit 101. The second elastic element 109 and the first elastic element 107 may be coil springs, but are not limited thereto.

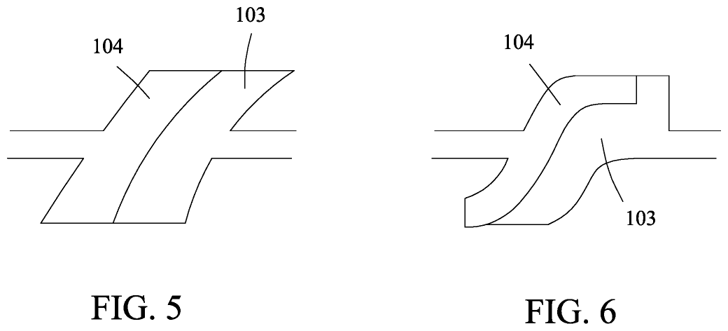

As shown in FIGS. 1, and 12-15, the first blocking body 103 and the second blocking body 104 therebetween may have an engaged structure with an inclined face, the first blocking body may have a first inclined face C1, and the second blocking body may have a second inclined face C2. As shown in FIGS. 5 and 6, the first blocking body 103 or the second blocking body 104 may also have an engaged structure with an arc face or an engaged structure with a curved face, however, the shape is not limited thereto. The first blocking body 103 or the second blocking body 104 may also have an engaged structure with a stepped face, a convex face, or a concave face.

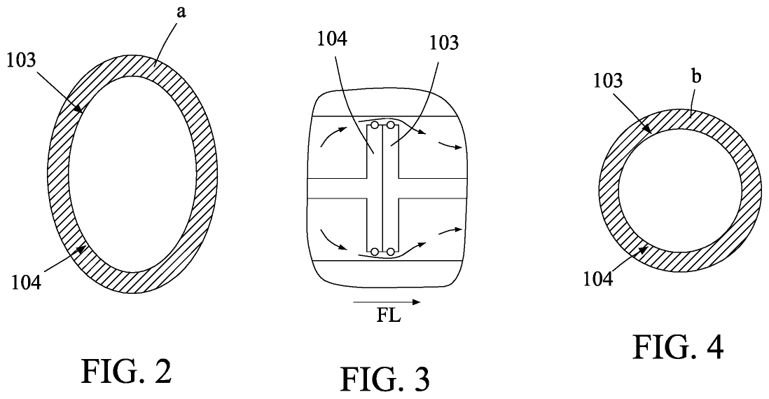

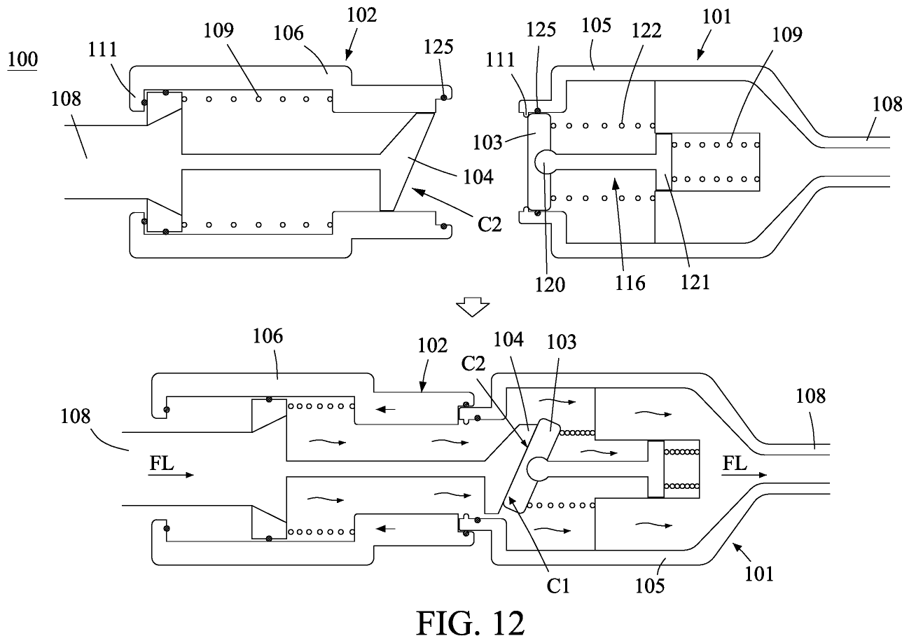

As shown in FIGS. 2-4 and referring to FIGS. 1, 12-15, in an embodiment, a first area a of the flow line FL generated by the first blocking body 103 or the second blocking body 104, that is not perpendicular to the conduction direction F1 shown in FIG. 1, is greater than a second area b of the flow line FL generated when the first blocking body 103 and the second blocking body 104 are perpendicular to the conduction direction F1. Since the first blocking body 103 and the second blocking body 104 are not perpendicular to the conduction direction FL, the area of the orthographic projection after engagement will be smaller than the orthographic projection area when the first blocking body 103 and the second blocking body 104 are perpendicular to the conduction direction FL, and thus they and the first body portion 105 therebetween have a wider flow line FL. In FIGS. 12-14, the first blocking body 103 will rotate after being pushed, thereby reducing the area of the orthographic projection and increasing the area of the flow line FL.

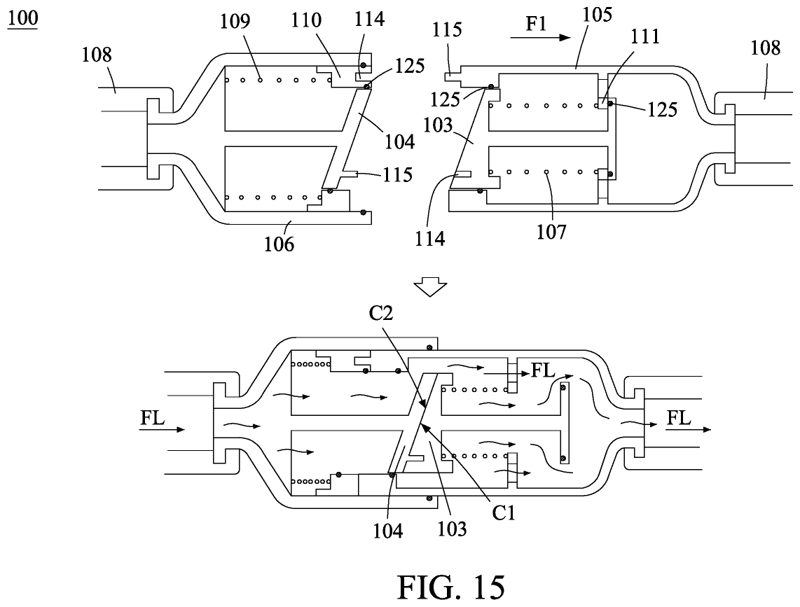

As shown in FIGS. 1 and 15, in an embodiment, the fluid conduit structure 100 of an embodiment of the present disclosure includes an abutment section 110. The abutment section 110 is provided between the second body portion 106 and the second blocking body 104. The second elastic element 109 is abutted between an inner wall of the second body portion 106 and the abutment section 110. The second blocking body 104 is used to push against the first blocking body 103, and the abutment section 110 is used to be pushed by the first body portion 105, so that the second conduit 102 is connected to the first conduit 101. The caliber and shape of the abutment section 110 corresponds to the caliber and shape corresponding to the condition that the first body portion 105 accommodates the first blocking body 103 when the first conduction space S1 is closed. When the second conduit 102 is connected to the first conduit 101, the second body portion 106 is sleeved on the first body portion 105. The caliber of the abutment section 110 is smaller than the caliber of the interior (i.e., the first conduction space S1) of the first body portion 105, so when the second blocking body 104 pushes the first blocking body 103 into the interior of the first body portion 105 having a larger caliber, the flow line FL may be generated.

As shown in FIGS. 12-14, the first body portion 105 and the second body portion 106 have narrower calibers corresponding to each other at the end to respectively accommodate the first blocking body 103 and the second blocking body 104. When the second blocking body 104 pushes the first blocking body 103 into the interior of the first body portion 105 having a larger caliber, the flow line FL may be generated.

As shown in FIGS. 1, 7, 10, and 12-15, in an embodiment, the first body portion 105 or the second body portion 106 is provided with a blocking section 111. The blocking section 111 is used to stop the first blocking body 103 when the first blocking body 103 closes the first conduction space S1, or to stop the second blocking body 104 when the second blocking body 104 closes the second conduction space S2. In FIGS. 1 and 15, only the first body portion 105 is provided with the blocking section 111. The blocking section 111 may be a convex part or a bent end part. In FIGS. 1 and 15, the first body portion 105 is provided with the blocking section 111 in the first conduction space S1. The first blocking body 103 may include a blocking body section 112 and a corresponding blocking body section 113 extending to the blocking body section 112. The blocking section 111 is located between the corresponding blocking body section 113 and the blocking body section 112, and the first elastic element 107 is abutted between the blocking section 111 and the blocking body section 112. The blocking section 111 may be provided with a flow line FL to conduct fluid. In FIG. 15, the abutment section 110 is concave-convex matching with the first body portion 105, or the first blocking body 103 is concave-convex matching with the second blocking body 104. The abutment section 110 and the first blocking body 103 may have an interlocking concavity 114, and the first body portion 105 may have an interlocking protrusion 115.

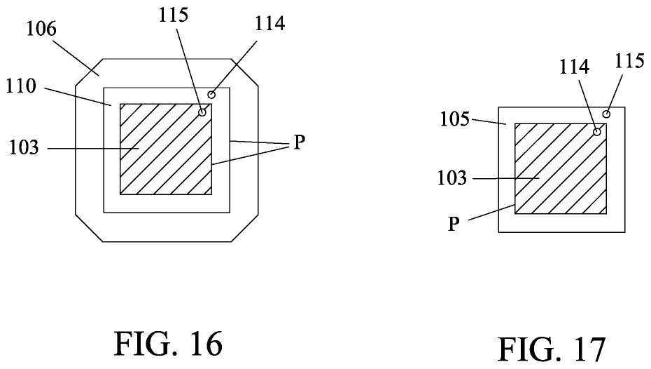

As shown in FIGS. 16 and 17 and referring to FIGS. 1 and 15, in an embodiment, the second body portion 106 and the abutment section 110 therebetween have an anti-rotation part P, or the second blocking body 104 and the abutment section 110 therebetween have an anti-rotation part P, or the first body portion 105 and the first blocking body 103 therebetween have an anti-rotation part P. As long as a non-circular configuration is used and the socketing is carried out conformably, it can have the effect of anti-rotation part P.

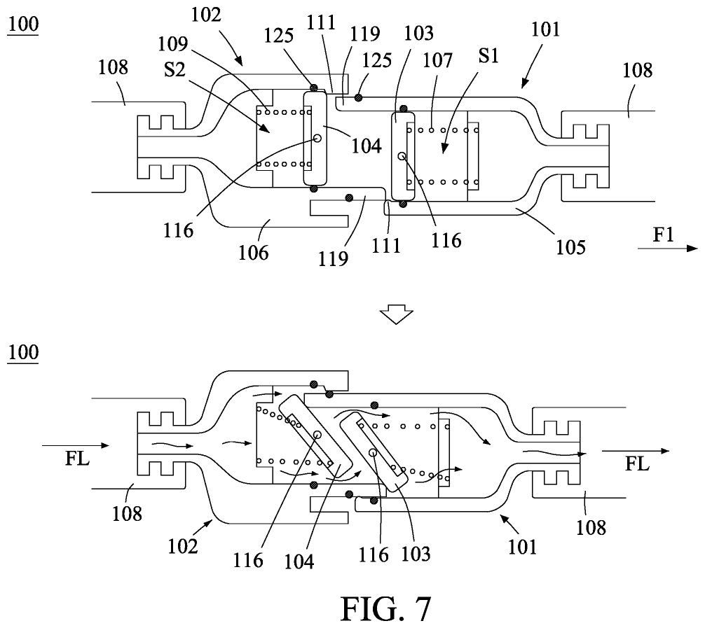

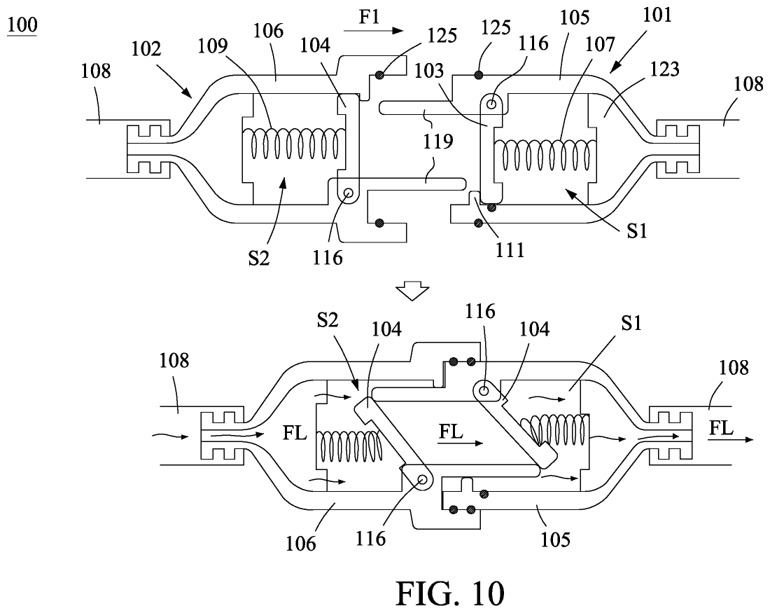

As shown in FIGS. 7, 9, 10, and 12-14, the fluid conduit structure 100 of an embodiment of the present disclosure may further include a joining section 116 for movably assembling or rotatably assembling the first blocking body 103 to the first body portion 105. In FIGS. 7 and 10, the joining section 116 may also be used to movably assemble the second blocking body 104 to the second body portion 106.

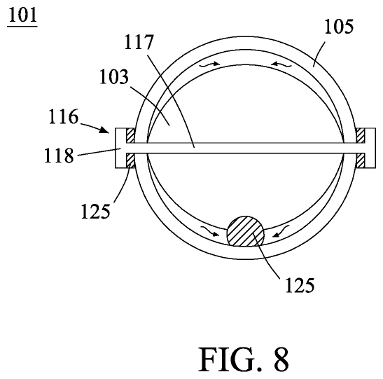

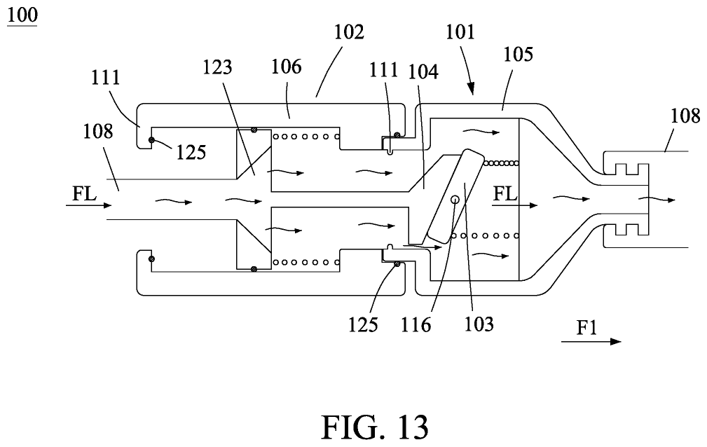

As shown in FIG. 8 and referring to FIGS. 7 and 13, the joining section 116 includes a shaft body 117 pivoting or penetrating the first body portion 106, or two limiting convex parts 118 connected to two sides of the shaft body 117 and located outside the first body portion 106, or the first blocking body is connected to the shaft body. The joining section 116 of FIG. 8 may also be applied to the second body portion 106 and the second blocking body 104 as shown in FIG. 7. In FIG. 13, the second blocking body 104 has an inclined face for pushing against the first blocking body 103, so that the first blocking body 103 is rotated to open the first conduction space S1.

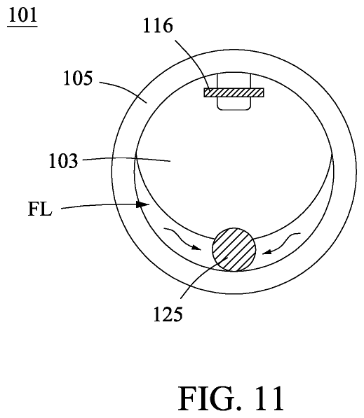

Referring to FIGS. 9 to 11, in an embodiment, as shown in FIG. 9, the joining section 116 is a shaft body pivoting or penetrating the first blocking body 103 to a side of an inner wall of the first body portion 106. As shown in FIG. 10, the joining section 116 is also used to pivot the second blocking body 104 to a side of the inner wall of the second body portion 106. In FIG. 9, the connector device 124 is provided with a pushing body 119 to push the first blocking body 103. In FIG. 10, both the second body portion 106 and the first body portion 105 may be provided with the pushing body 119, but not limited thereto. The second blocking body 104 is used to be pushed by the pushing body 119 of the first body portion 105, and the first blocking body 103 is to be pushed by the pushing body 119 of the second body portion 106. Similarly, the first body portion 105 and the second body portion 106 as shown in FIGS. 7 and 10 are also provided with the pushing body 119. The pushing body 119 may also be applied to FIGS. 1, and 12-15, and substitute for the second blocking body 104 to push against the first blocking body 103 to conduct the first conduit 101 and the second conduit 102, and is not perpendicular to the conduction direction F1.

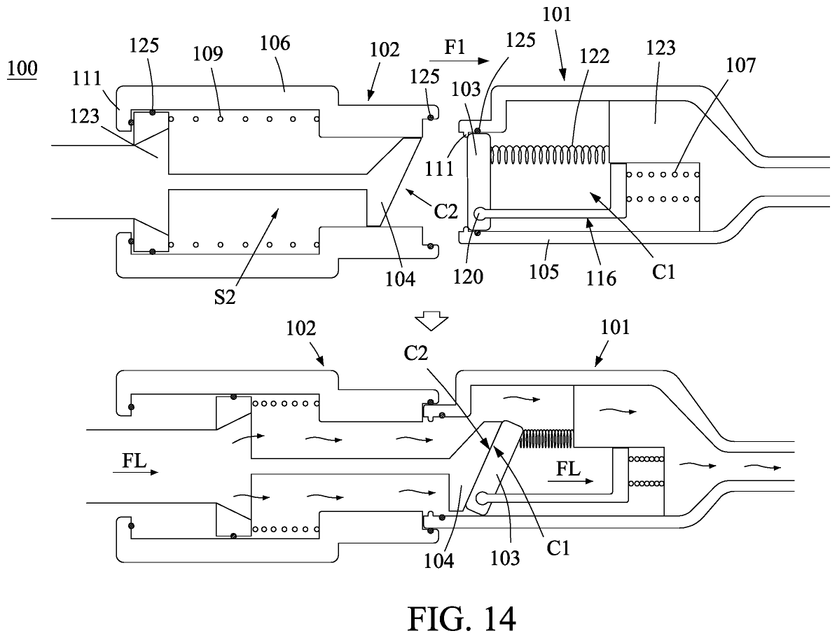

As shown in FIGS. 12 and 14, in an embodiment, two ends of the joining section 116 may respectively include a rotary joint 120 and a contacting section 121. The rotary joint 120 is rotatably connected to the first blocking section 103, and the contacting section 121 is abutted against the first elastic element 107. The fluid conduit structure 100 of an embodiment of the present disclosure may further include a balanced elastic element 122. The balanced elastic element 122 is directly abutted between the first blocking body 103 and the first body portion 105. In FIG. 12, the rotary joint 120 is rotatably connected to a center of the first blocking body 103, and the balanced elastic element 122 surrounds the joining section 116. In FIG. 14, the rotary joint 120 is rotatably connected to one end of the first blocking body 103, and the balanced elastic element 122 is arranged in parallel with the joining section 116. The balanced elastic element 122 may be a coil spring, but it is not limited thereto.

As shown in FIGS. 1, 7, 10, and 13-15, the first body portion 105 is provided with a base 123 in the first conduction space S1, or the second body portion 106 is provided with a base 123 in the second conduction space S2 to abut against the first elastic element 107 or the second elastic element 109. The base 123 is provided with a flow line FL to conduct fluid. In FIG. 9, the connector device 124 is provided with the base 123, and the base 123 is provided with a flow line FL.

As shown in FIGS. 1, and 7-15, the fluid conduit structure 100 of an embodiment of the present disclosure may further include a stopping part 125 to stop the fluid. The stopping part 125 may be an elastic rubber ring, and may be sleeved to be disposed on the first body portion 105, the second body portion 106, the first blocking body 103 and extension structures thereof, the second block 104 and its extension structure, the shaft body 117 of the joining section 116, the connector device 124, the abutment section 110, or any structure that needs to stop the fluid after the first conduit 101 docking with the second conduit 102.

While the present invention has been described by means of specific embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. A fluid conduit structure, comprising:
a first conduit, comprising a first body part;
a second conduit, comprising a second body part, the first body portion and the second body portion extending along a conduction direction;
a first blocking body, movably assembled to the first body portion and is used to close the first conduit; and
a second blocking body, provided in the second body portion and is used to close the second conduit;
wherein the second blocking body is used to push against the first blocking body, and when the second blocking body pushes against the first blocking body, the first blocking body and the second blocking body open the first conduit and the second conduit to generate a flow line in the first body part, and the first blocking body or the second blocking body is not perpendicular to the conduction direction.

2. A fluid conduit structure, comprising:
a first conduit, comprising a first body part;
a first blocking body, movably assembled to the first body portion and is used to close the first conduit; and
a second blocking body or a pushing body, the second blocking body or the pushing body is used to push against the first blocking body, and when the second blocking body or the pushing body pushes against the first blocking body, the first blocking body opens the first conduit to generate a flow line in the first body part, and the first blocking body or the second blocking body or the pushing body is not perpendicular to the conduction direction.

3. The fluid conduit structure according to claim 2, wherein the first blocking body or the second blocking body has an engaged structure with an inclined face, stepped face, curved face, arc face, convex face, or concave face.

4. The fluid conduit structure according to claim 2, wherein an area of the flow line generated by the first blocking body or the second blocking body that is not perpendicular to the conduction direction is greater than an area of the flow line generated when the first blocking body and the second blocking body are perpendicular to the conduction direction.

5. The fluid conduit structure according to claim 2, wherein:
the first body portion has a first conduction space, the first blocking body is located in the first conduction space, the fluid conduit structure further comprises a first elastic element, the first elastic element is abutted between the first body portion and the first blocking body, so that the first blocking body remains closing the first conduction space, and the first blocking body is used to be pushed to make the first conduction space connected.

6. The fluid conduit structure according to claim 2, further comprising a second elastic element in the second conduit, the first body portion has a first conduction space, the second conduit comprises the second body portion, the second body portion has a second conduction space, the second blocking body is located in the second conduction space and movably assembled to the second body part, the second elastic element is abutted between the second body portion and the second blocking body, so that the second blocking body remains closing the second conduction space, the second conduit and the first conduit are engaged, so that the first blocking body and the second blocking body leave the positions that close the first conduction space and the second conduction space, and then the second conduit is connected to the first conduit.

7. The fluid conduit structure according to claim 2, wherein the first body portion or the second body portion is provided with a pushing body used to push each other.

8. The fluid conduit structure according to claim 2, wherein the first body portion or the second body portion is provided with a blocking part, the blocking section is used to stop the first blocking body when the first blocking body closes a first conduction space of the first body part, or to stop the second blocking body when the second blocking body closes a second conduction space of the second body part.

9. The fluid conduit structure according to claim 2, further comprising a joining section for movably assembling the first blocking body to the first body part, the joining section comprises a shaft body pivoting or penetrating the first body part, or two limiting convex parts connected to two sides of the shaft body and located outside the first body part, or the first blocking body is connected to the shaft body; or further comprising a joining section for movably assembling the first blocking body to the first body portion or movably assembling the second blocking body to the second body part, or the joining section comprises a shaft body pivoting or penetrating the first body portion or the second body part, or two limiting convex parts connected to two sides of the shaft body or located outside the first body portion or the second body part, or the first blocking body or the second blocking body is connected to the shaft body; or further comprising a joining section for movably assembling the first blocking body to the first body portion or movably assembling the second blocking body to the second body part, or the joining section is a shaft body, or for pivoting the first blocking body to a side of an inner wall of the first body part, or for pivoting the second blocking body to a side of an inner wall of the second body part.

10. The fluid conduit structure according to claim 2, further comprising a second conduit, the second conduit is provided with a pushing body used to push the first blocking body; or further comprising a second conduit, an abutment section or a second elastic element, or the second conduit comprises a second body part, or the second body portion has a second conduction space, or the second blocking body is located in the second conduction space of the second conduit and disposed in the second body portion of the second conduit, or the abutment section is provided between the second body portion and the second blocking body, or the second elastic element is abutted between an inner wall of the second body portion and the abutment section, or the second blocking body is used to push against the first blocking body, or the abutment section is used to be pushed by the first body part, or the second conduit is connected to the first conduit.

11. The fluid conduit structure according to claim 2, wherein the second blocking body has an inclined face, or the fluid conduit structure further comprises a joining section, or two ends of the joining section respectively comprise a rotary joint and a contacting section, or a rotary joint is rotatably connected to the first blocking part, or a contacting section is abutted against the first elastic element;
or the second blocking body has an inclined face, or the fluid conduit structure further comprises a joining section, or the joining section rotatably assembles the first blocking body to the first body part, or the inclined face of the second blocking body is used to push against the first blocking body, or to rotate the first blocking body to open the first conduction space.

12. The fluid conduit structure according to claim 2, further comprising a balanced elastic element, the balanced elastic element is directly abutted between the first blocking body and the first body part.

13. The fluid conduit structure according to claim 2, wherein a rotary joint is rotatably connected to a center of the first blocking body, or a balanced elastic element surrounds a joining section; or a rotary joint is rotatably connected to one end of the first blocking body, or a balanced elastic element is arranged in parallel with a joining section.

14. The fluid conduit structure according to claim 2, wherein the first blocking body and the second blocking body respectively have an inclined face that matches each other, or an abutment section is concave-convex matching with the first body part, or the first blocking body is concave-convex matching with the second blocking body.

15. The fluid conduit structure according to claim 2, wherein the first body portion is provided with a blocking section in a first conduction space thereof, or the first blocking body comprises a blocking body section or a corresponding blocking body section extending to the blocking body section, or the blocking section is located between the corresponding blocking section or the blocking body section, or a first elastic element is abutted between the blocking section or the blocking body section.

16. The fluid conduit structure according to claim 15, wherein the blocking section is provided with the flow line.

17. The fluid conduit structure according to claim 2, wherein the second blocking body corresponds to the second body section, the second body portion is provided with a base, the second blocking body is connected to the base, and the base is with the flow line.

18. The fluid conduit structure according to claim 2, wherein the second body portion and the abutment section therebetween have an anti-rotation part, or the second blocking body and the abutment section therebetween have an anti-rotation part, or the first body portion and the first blocking body therebetween have an anti-rotation part.

19. An application method of a fluid conduit structure, using the fluid conduit structure as claimed in claim 1 to conduct the first conduit to another conduit.

20. An application method of a fluid conduit structure, using the fluid conduit structure as claimed in claim 2 to conduct the first conduit to another conduit.
